(19) United States
(12) Patent Application Publication
(10) Pub. No.: US 2010/0087178 A1
(43) Pub. Date: Apr. 8, 2010

(54) METHOD AND SYSTEM FOR BROWSER PAGE LOAD NOTIFICATION

(76) Inventor: RAYMOND VANDER VEEN, Waterloo (CA)

Correspondence Address: BENNETT JONES LLP, 3400 ONE FIRST CANADIAN PLACE, PO BOX 130, TORONTO, ON, M5X 1A4, CA

(21) Appl. No.: 12/245,325

(22) Filed: Oct. 3, 2008

(51) Int. Cl. H04M 3/493

(52) U.S. Cl. 455/414.2

(57) ABSTRACT

A method, system and mechanism for browser page load or other event notification. According to an embodiment, a notification is generated at the mobile communication device when page is downloaded or received at the mobile communication device. According to an embodiment, the notification is selectable by the user and comprises a ringtone notification and/or a device vibrate notification.

### FIELD OF THE APPLICATION

The present application relates to wireless packet data service networks, and more particularly, to a method and system for page load notification on a browser, for example, a browser running on a mobile communication device.

### BACKGROUND OF THE APPLICATION

Handheld wireless devices with Internet browser capabilities have become the norm. The speed of webpage downloads to a browser running on a handheld device will be dependent on the processing resources or processing speed available at the device. Other factors can affect the speed of webpage downloads to the device. Such factors include webpage size and wireless coverage area. A large webpage, for example, a webpage containing a lot of images, will take longer to download to the browser on the handheld device. In an area with low wireless coverage, the throughput of data to the browser will tend to be lower.

In view of these deficiencies in the art, a user will typically engage in another activity while waiting for a webpage to download. For a handheld device, the activity can include reading or responding to emails. Once the webpage has completed its download to the handheld device, it is desirable to notify the user in order to turn the user's attention back to the webpage download. Accordingly, there remains a need for improvements in the art.

### BRIEF DESCRIPTION OF THE DRAWINGS

Reference will now be made to the accompanying drawings which show, by way of example, embodiments according to the present application, and in which:

FIG. 1 shows in diagrammatic form an exemplary network environment suitable for operating an embodiment according to the present application;

FIG. 2 shows in schematic form an exemplary mobile wireless communication device which is capable of communicating within the network environment of FIG. 1;

FIG. 3 shows in diagrammatic form a screen shot for a notifications menu for a mobile communications device in accordance with an embodiment;

FIG. 4 shows in diagrammatic form a screen shot for configuring a notification for a page download in accordance with an embodiment; and

FIG. 5 shows in flowchart form a process for generating a notification for page download for a mobile communications device according to an embodiment.

Like reference numerals indicate like or corresponding elements in the drawings.

### DETAILED DESCRIPTION OF THE EMBODIMENTS

The present application comprises a method, system and mechanism for generating a notification at a device.

According to one embodiment, the present application comprises a mechanism for notifying a user of a mobile communication device of an event comprising downloading a page to the mobile communication device, the mechanism comprises: means for monitoring reception of a page at the mobile communication device; means for generating a notification in response to reception of the page; and means for rendering the notification to the user of the mobile communication device.

According to another embodiment, the present application comprises a method for providing a notification to a user of a mobile communication device in response to an event at the mobile communication device, the method comprises the steps of: monitoring an event; upon occurrence of the event, generating a notification; and rendering the notification at the mobile communication device.

According to another embodiment, the present application comprises a computer program product for providing notification of an event at a mobile communication device, the computer program product comprises, a storage medium configured to store computer readable instructions; the computer readable instructions including instructions for, monitoring an event; upon occurrence of the event, generating a notification; and rendering the notification at the mobile communication device.

According to another embodiment, the present application comprises a mobile communication device comprises, a user interface including a display module and a keypad; a communication module configured for providing communication with a network; a controller operatively coupled to the user interface and the communication module, and including a browser module configured for accessing a page over the network; and the controller includes a notification module operatively configured for generating a notification when the page is received.

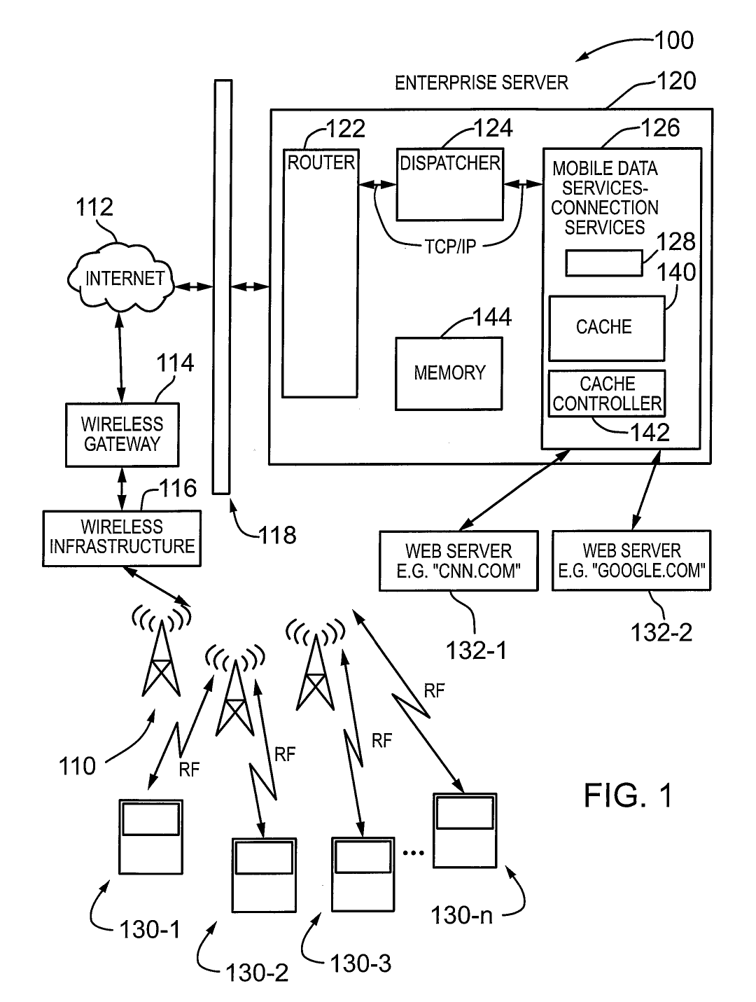

Reference is first made to FIG. 1, which shows in diagrammatic form an exemplary network environment 100 wherein an embodiment as described herein may be practiced. The network environment 100 comprises a wireless network 110, the Internet 112, a wireless gateway 114, a wireless infrastructure 116, and an enterprise server 120. The wireless network 110 serves a plurality of users, each having a mobile communication device (MCD) 130, indicated individually as 130-1, 130-2, . . . 130-n.

The wireless gateway 114 and the wireless infrastructure 116 provide a link between the Internet 112 and the wireless network 110. The wireless infrastructure 116 determines the most likely network for locating a given user and tracks the users as they roam between countries or networks. A message is then delivered to the mobile communication device 130 via wireless transmission, typically at a radio frequency (RF), from a base station in the wireless network 110 to the mobile device 130. The wireless network 110 may comprise any wireless network over which messages may be exchanged with a mobile communication device.

The wireless infrastructure 116 includes a series of connections to wireless network 110. These connections could be Integrated Services Digital Network (ISDN), Frame Relay or T1 connections using the TCP/IP protocol used throughout the Internet. As used herein, the term “wireless network” is intended to include three different types of networks, those being (1) data-centric wireless networks, (2) voice-centric wireless networks and (3) dual-mode networks that can support both voice and data communications over the same physical base stations. Combined dual-mode networks include, but are not limited to, (1) Code Divisional Multiple Access (CDMA) networks, (2) the Group Special Mobile or the Global System for Mobile Communications (GSM) and the General Packet Radio Service (GPRS) networks, and (3) future third-generation (3G) networks like Enhanced Data-rates for Global Evolution (EDGE) and Universal Mobile Telecommunications Systems (UMTS). Some older examples of data-centric networks include the Mobitex™. Radio Network and the DataTAC™. Radio Network. Examples of older voice-centric data networks include Personal Communication Systems (PCS) networks like GSM, and TDMA systems.

The enterprise server 120 may be implemented, for example, on a network computer within a firewall 118 for a corporation, a computer within an ISP system or the like. The enterprise server 120 provides an interface for email exchange over the Internet 112 and web access on the Internet 112 for mobile communication devices 130 equipped with a browser or having browser capability as will be described in more detail below.

The enterprise server 120, for example, implemented as a BlackBerry® Enterprise Server or BES, comprises a software module running on a server that acts as the centralized link between the mobile wireless communication devices 130, the wireless networks 110 and the enterprise applications. The server 120 integrates with enterprise messaging (e.g. Microsoft Exchange email system) and collaboration systems to provide the users of the mobile communication devices 130 with access to email, enterprise instant messaging and personal information management tools. All data between applications and the mobile communication devices 130 flows centrally through the enterprise server 120. As shown in FIG. 1, the enterprise server 120 comprises a router 122, a dispatcher 124 and a Mobile Data Services-Connection Services (MDS-CS) module or system 126.

The router 122 is designed to connect to the wireless network 110 to route data to and from the mobile wireless communication devices 130. The dispatcher 124 is designed to compress and encrypt the data communications for the mobile communication devices 130. The dispatcher 124 routes the data through the router 122 to and from the wireless network 110. The Mobile Data Services module 126, for example, the BlackBerry® MDS™ Connection Service, functions as a gateway and is designed to manage interactions and requests between mobile wireless communication devices 130 (for example, BlackBerry® handheld devices) and enterprise applications. The Mobile Data Services system 126 enables always-on/push-based access to enterprise applications and information using the mobile communication device 130, browser and software development tools. The MDS 126 provides connectivity (i.e. HTTP/HTTPS) to the Internet 112. In addition, the MDS 126 provides an extensible and secure interface for extending corporate applications and the corporate Intranet based on existing web standards. Through the Mobile Data Service, users of the mobile communication devices 130 have the ability to access existing corporate data stores and enterprise applications, such as CRM, ERP, business intelligence and document management systems wirelessly.

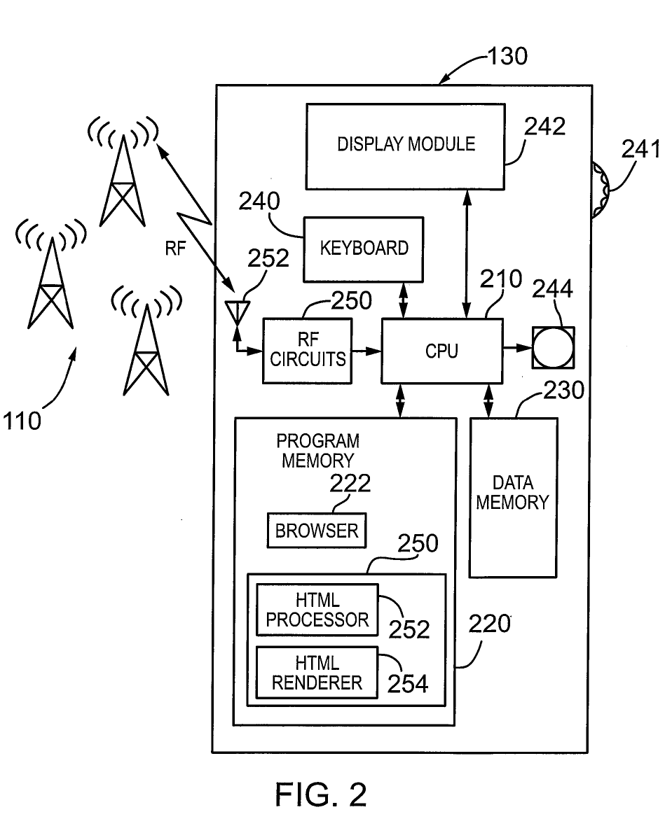

Reference is next made to FIG. 2, which shows in more detail an exemplary implementation of the mobile communication device 130. The mobile communication device 130 comprises a central processing unit or CPU 210. The CPU 210 operates under the control of a program (i.e. firmware or software) stored in program memory 220. The CPU 210 is also provided with data memory 230. The CPU 210 is also operatively coupled to a keyboard and track wheel 240, a display module 242 and an audio transducer or speaker 244. In addition to the program executable code provided for performing the functions associated with the operation of the mobile communication device 130, the program memory 220 includes a browser program 222. The browser program 222 allows a user to access web pages on the Internet 112 using the mobile communication device 130, i.e. utilizing a graphical user interface comprising, for example, the keyboard 240 and the display module 242 and/or a track wheel 241.

As shown, the mobile communication device 130 includes a RF, demodulation/modulation and decoding/coding circuits 250, and a suitable RF antenna 252. The RF demodulator/modulator and decoder/coder circuits 250 and the RF antenna 252 are operatively coupled to the CPU 210 and provide an interface for wireless communication with the wireless network 110. The particular implementation details of the RF circuits will be within the understanding of those skilled in the art, and is therefore not described in further detail.

To browse the Internet, the user invokes the browser program 222 in the mobile communication device 130 and using the graphical user interface (i.e. the display 242, the keyboard 240 and/or a thumb-operated track wheel 241) enters the URL or a bookmark for a website of interest, for example, http://www.google.com. The browser 222 converts the user entry into a HTTP request and sends the request to the enterprise server 120. The enterprise server 120, i.e. the MDS-CS 126, relays the HTTP request to the web server, for example, web server 132 for “google.com”. In response to the request, the web server 132-1 returns the requested or corresponding webpage, which is relayed by the MDS-CS 126 to the mobile communications device 130.

According to an embodiment, the mobile communication device 130 includes a mechanism for generating a notification when a webpage request is completed, e.g. a page is loaded on the browser program 222, or other events/actions associated with operation of the mobile communication device 130 and/or applications running on the device 130. According to an embodiment, the mechanism is implemented as a component or module 250 in the browser program 222. The notification module 250 provides a mechanism for generating a notification to a user of the mobile communication device 130 that a webpage (e.g. a requested page) has been downloaded or received at the mobile communication device 130 (e.g. the page has been loaded on the browser program 222, as will be described in more detail below.

According to one embodiment, the notification module 250 is implemented with an HTML based mechanism comprising an HTML processor 252 and an HTML renderer 254 as depicted in FIG. 2. According to an embodiment, the HTML processor 252 and the HTML renderer 254 comprise one or more software modules, objects and/or code components to provide the functionality as described in more detail below. The particular implementation and/or coding details will be within the understanding of one skilled in the art.

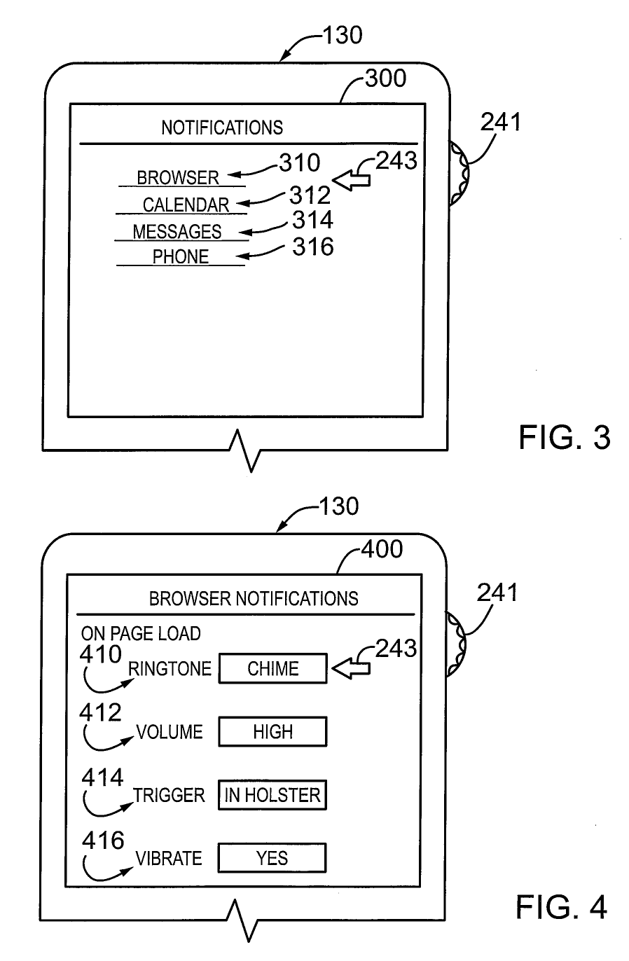

Reference is next made to FIG. 3, which shows a screen shot of a notification setup or configuration screen or window 300 in the mobile communication device 130 according to an embodiment. The notification configuration screen 300 allows the user to configure the notification module 250 to generate one or more notifications associated with the operation of the mobile communication device 130 and/or applications running or executed on the device 130. According to an embodiment, the notification configuration screen 300 provides the capability to configure or set up notifications associated with the browser program or application 310, a calendar program or application 312, a messages application 314 and/or a phone application 316. The notifications, for example, the browser notification 310 may be implemented as a hypertext link which in response to user activation causes a browser notifications screen 400 as shown in FIG. 4 to be displayed, i.e. on the display module 242 (FIG. 2) of the device 130.

According to an embodiment, the browser notifications screen 400 as shown in FIG. 4 allows a user to configure a notification which is triggered or generated in response to a webpage request be completed, e.g. the webpage being loaded on the browser program 122 or “On Page Load”. As shown in FIG. 4, the browser notifications screen 400 comprises a “Ringtone” select input field 410, a “Volume” level input field 412, a “Trigger” input field 414, and a “Vibrate” enable/disable control 416. The Ringtone input field 410 comprises a “choice field” which allows a user to specify a ringtone (for example, selected from a list of ringtones in a drop-down box) to be played (for example, on a speaker in the device 130) in response to the occurrence of the page load event. The Volume input field 412 comprises an input field which allows a user to set the volume at which the ringtone should sound or be played on the speaker. The Trigger field 414 comprises a “choice field” which allows a user to specify under what circumstances the notification process should be triggered. According to an embodiment, the trigger choices comprise “Always” and “In Holster”. If the “In Holster” choice is selected, then the notification is triggered when the device 130 is put or carried in a holster. For example, the user may put the device 130 into its holster if the loading of a webpage appears to be taking a significant amount of time. The Vibrate field 416 comprises a “choice field” which is used to specify whether the device 130 should vibrate as part of the notification (for devices equipped with a vibrate mechanism). The user navigates, i.e. moves between the input fields, the browser notifications screen 400 using the keyboard 240 (FIG. 2) and/or the track wheel 241 (FIG. 2). The active or selected field is indicated by a cursor icon 243.

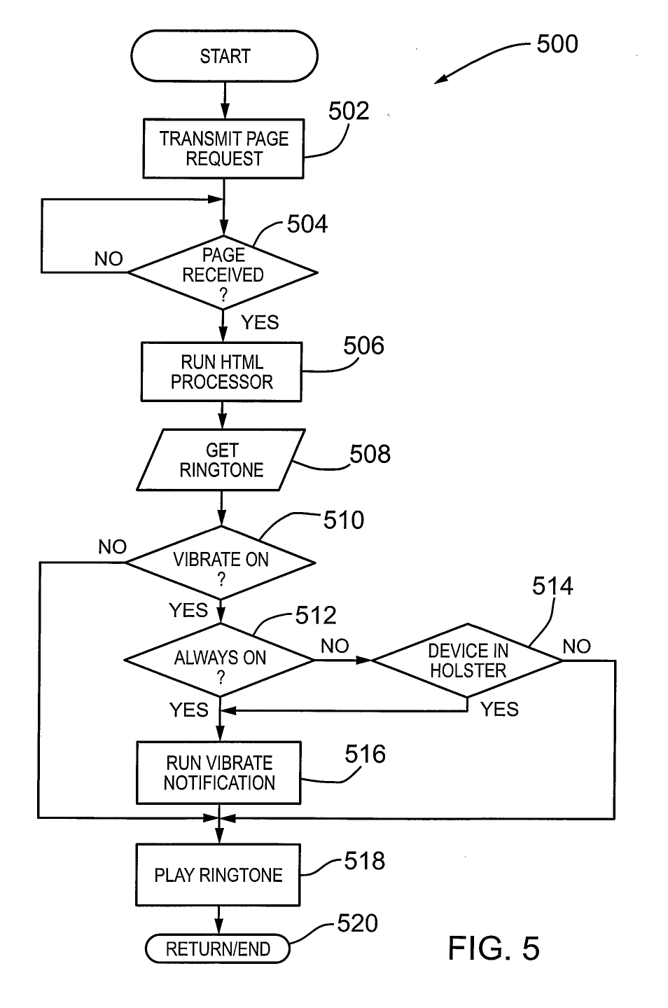

Reference is next made to FIG. 5, which shows in flowchart form an exemplary process or method for operation according to an embodiment. The process or method of operation is indicated generally by reference 500 and starts with a transmit page request. For example, the user uses the browser program 222 (FIG. 2) in the mobile communication device 130 (FIG. 1) and using the graphical user interface (i.e. the display 242 (FIG. 2), the keyboard 240 (FIG. 2) and/or a thumb-operated track wheel 241 (FIG. 2)) enters the URL or a bookmark for a website of interest, for example, http://www.google.com. The browser 222 (FIG. 2) converts the user entry into a HTTP request and sends the request to the enterprise server 120 (FIG. 1). The enterprise server 120 (FIG. 1), i.e. the MDS-CS 126 (FIG. 1), relays the HTTP request to the web server, for example, web server 132 (FIG. 1) for “google.com”. In response to the request, the web server 132-1 (FIG. 1) returns the requested or corresponding webpage, which is relayed by the MDS-CS 126 (FIG. 1) to the mobile communications device 130 (FIG. 1).

Referring back to FIG. 5, the HTML processor 252 (FIG. 2) waits for the page to be received as indicated at block 504. According to one embodiment, the HTML processor 252 (FIG. 2) is responsive to a page load signal from the browser 222 (FIG. 2), and begins execution of a notification, as indicated at block 506. According to another embodiment, the HTML processor 252 (FIG. 2) can be responsive to a page loading signal, i.e., corresponding to the page being substantially downloaded or received at the device, for example, 80% received. According to one embodiment, the HTML processor 252 (FIG. 2) is configured to generate a ringtone (for example as described above) and as indicated in block 508, the HTML processor 252 (FIG. 2) retrieves the ringtone, for example, from memory 230 (FIG. 2). Next in decision block 510 a check is made to determine if the vibrate notification feature has been activated (for example as described above). If the vibrate notification is activated, then a check is made in decision block 512 to determine if the notification is for “In Holster” only or “Always On”. If the notification is for “In Holster” only, then a check is made in decision block 514 to determine if the device is loaded in the holster, and if yes, then notification alert is executed, e.g. the HTML processor 252 (FIG. 2) invokes the HTML renderer 254 (FIG. 2) to actuate the device vibrate mechanism (as indicated by block 516) and to play the ringtone (as indicated by block 518). If the device is not in the holster (as determined in decision block 514), then the notification alert is suppressed, the HTML renderer 254 (FIG. 2) may play the ringtone without vibrate as indicated by block 518. If the trigger notification is “Always On”, then the check if the device is in the holster in decision block 514 is bypassed, and the vibrate mechanism is activated in block 516 and the ringtone played in block 518. The notification process is terminated, i.e. control is returned, in block 520.

While the notification mechanism has been described with a ringtone and/or vibrate, it will be appreciated that the notification may comprise other forms according to further embodiments. For example, the notification may comprise activation, for example flashing, of the backlight for the display module 242 (FIG. 2).

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method for providing a notification to a user of a mobile communication device in response to a page download at the mobile communication device, said method comprising the steps of:
monitoring receipt of a page download;
upon receipt of the page download, generating a notification; and
rendering the notification at the mobile communication device.

2. The method as claimed in claim 1, wherein said notification comprises one or more of activating a chime or activating a vibrate mechanism for the mobile communication device.

3. The method as claimed in claim 2, further including the step of selectively activating the vibrate mechanism.

4. The method as claimed in claim 3, wherein said vibrate mechanism is activated when the mobile communication device is being carried in a holster.

5. The method as claimed in claim 2, further including the step of selecting one of said notifications in response to an input from the user.

6. A mechanism for notifying a user of a mobile communication device for downloading a page to the mobile communication device, said mechanism comprising:
means for monitoring reception of a page at the mobile communication device;
means for generating a notification in response to reception of the page; and
means for rendering the notification at the mobile communication device.

7. The mechanism as claimed in claim 6, wherein said reception of a page comprises receiving a substantive portion of the page.

8. The mechanism as claimed in claim 6, further including means for selecting a notification, said notification comprising one or more of a ringtone or a device vibrate.

9. The mechanism as claimed in claim 8, further including means for selectively activating said device vibrate.

10. The mechanism as claimed in claim 9, wherein said device vibrate is active when the mobile communication device is being carried in a holster.

11. The mechanism as claimed in claim 8, wherein said means for monitoring comprise a code module in an HTML processor.

12. The mechanism as claimed in claim 8, wherein said means for generating comprise a code module in an HTML processor.

13. The mechanism as claimed in claim 8, wherein said means for rendering comprise a code module in an HTML renderer.

14. The mechanism as claimed in claim 8, wherein said means for selecting a notification comprise a graphical user interface screen displayed on the mobile communication device.

15. A computer program product for providing a notification of a page download at a mobile communication device, said computer program product comprising:
a storage medium configured to store computer readable instructions;
said computer readable instructions including instructions for,
monitoring receipt of a page download;
upon receipt of the page download, generating a notification; and
rendering the notification at the mobile communication device.

16. The computer program product as claimed in claim 15, wherein said notification comprises one or more of activating a chime or activating a vibrate mechanism for the mobile communication device.

17. The computer program product as claimed in claim 16, wherein said vibrate mechanism is activated when the mobile communication device is being carried in a holster.

18. A mobile communication device comprising:
a user interface including a display module and a keypad;
a communication module configured for providing communication with a network;
a controller operatively coupled to said user interface and said communication module, and including a browser module configured for accessing a page over the network; and
said controller including a notification module operatively configured for generating a notification when the page is received.

19. The mobile communication device as claimed in claim 18, wherein said notification module is configured to generate a notification screen for selecting said notification, and said notification comprises one or more of activating a chime or activating a vibrate mechanism.

20. The mobile communication device as claimed in claim 19, wherein said vibrate mechanism is activated when the mobile communication device is a holster.
